(19) United States
(12) Patent Application Publication
(10) Pub. No.: US 2025/0263269 A1
(43) Pub. Date: Aug. 21, 2025

(54) ELEVATOR CAR MOVEMENT MONITORING SYSTEM AND A METHOD FOR MONITORING ELEVATOR CAR MOVEMENT

(71) Applicant: KONE Corporation, Helsinki (FI)

(72) Inventors: Mari Zakrzewski, Helsinki (FI); Juho Lankinen, Helsinki (FI); Jaakko Huhtala, Helsinki (FI); Jimi Hytönen, Helsinki (FI); Matti Laakso, Helsinki (FI)

(73) Assignee: KONE Corporation, Helsinki (FI)

(21) Appl. No.: 19/049,664

(22) Filed: Feb. 10, 2025

(30) Foreign Application Priority Data
Feb. 20, 2024 (EP) 24158570.2

(51) Int. Cl. B66B 5/00

(52) U.S. Cl. CPC B66B 5/0037; B66B 5/0018

(57) ABSTRACT

An elevator car movement monitoring system includes an accelerometer and a data collection unit. The Accelerometer is attached to an elevator car and configured to produce acceleration representing acceleration of the elevator car. The data collection unit is configured to: obtain the acceleration data from the accelerometer; detect an elevator car start event and an elevator car stop event from the acceleration data, the acceleration data between the detected elevator car start event and the detected elevator car stop event representing elevator ride acceleration data; and execute at least one verification action to verify a correct detection the elevator car start event and/or the elevator car stop event. A method and an elevator system monitor elevator car movement.

### TECHNICAL FIELD

The invention concerns in general the technical field of elevator systems. Especially the invention concerns monitoring elevator car movement.

### BACKGROUND

An elevator system comprises at least one elevator car travelling, i.e. moving, along a respective at least one elevator shaft. Typically, the movement of the at least one elevator car, e.g. speed of the elevator car and acceleration of the elevator car, may be monitored by an elevator control system. In some cases, the movement of the at least one elevator car may be needed to be monitored by a monitoring system being independent of the elevator control system, i.e. by a monitoring system not being communicatively coupled to the elevator control system. An example of this kind of case may for example be monitoring of a third-party elevator system, where movement data representing the movement of the at least one elevator car cannot be obtained from the elevator control system, because communicatively coupling of the monitoring system to the elevator control system is not possible. The monitoring system may comprise one or more sensors for producing the movement data.

Because the elevator car may typically be stationary most of the time, constant measurement of the movement data by the one or more sensor device is not typically preferred. Therefore, the movement data is typically measured only when the elevator car is moving. When the movement data measurement is performed only when the elevator car is moving, one measurement typically comprises movement data of one elevator ride. In other words, the measurement should start, when the elevator ride starts and end when the elevator ride ends. However, if the start of the elevator ride and/or the end of the elevator ride are not correctly detected, it may lead to incorrect measurement data. For example, the measured movement data may comprise only a part of the elevator ride, e.g. the end of the elevator ride is missing. According to another example, one elevator ride may be divided into two consecutive measurements, e.g. first measurement data comprises the beginning of the elevator ride and second measurement data comprises the end of the same elevator ride. This kind of measurement error may for example occur in case of a two-speed elevator car, if the deceleration from a first speed to a second speed (i.e. a first deceleration) is incorrectly detected as the end of the elevator ride and the deceleration from the second speed to a stationary state (i.e. a second deceleration) is then incorrectly detected as the beginning of the next elevator ride. According to yet another example, the measured movement data may comprise parts of two consecutive elevator rides, e.g. the end of the first elevator ride and the beginning of the second elevator ride, wherein the first and the second elevator rides are consecutive elevator rides. According to yet another example, the measured movement data may comprise two or more consecutive elevator rides. This kind of measurement error may for example occur in elevator systems that have fast door opening and closing times.

The monitored movement data may for example be used in maintenance of the elevator system, e.g. in a determination of a maintenance need. Therefore, incorrect measurement data decreases the reliability of the determination of the maintenance need. It may for example lead to incorrect maintenance requests. Alternatively or in addition, it may for example lead to missing a need for maintenance.

Thus, there is a need to further develop solutions for monitoring elevator car movement.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present an elevator car movement monitoring system, a method, and an elevator system for monitoring elevator car movement. Another objective of the invention is that the elevator car movement monitoring system, the method, and the elevator system for monitoring elevator car movement improves the reliability of the monitoring of the elevator car movement.

The objectives of the invention are reached by an elevator car movement monitoring system, a method, and an elevator system as defined by the respective independent claims.

According to a first aspect, an elevator car movement monitoring system for monitoring movement of an elevator car is provided, wherein the elevator car movement monitoring system comprises: an accelerometer attached to an elevator car and configured to produce acceleration data representing acceleration of the elevator car, and a data collection unit configured to: obtain the acceleration data from the accelerometer; detect an elevator car start event and an elevator car stop event from the acceleration data, wherein the acceleration data between the detected elevator car start event and the detected elevator car stop event represents elevator ride acceleration data; and execute at least one verification action to verify a correct detection the elevator car start event and/or the elevator car stop event.

The at least one verification action may comprise at least one of the following: a duration verification action, a movement direction verification action, a movement state verification action, a disconnected ride verification action, a connected ride verification action.

The execution of the duration verification action may comprise that the data collection unit is configured to verify that the detected elevator car stop event is actually the end of an elevator ride.

The execution of the movement direction verification action may comprise that the data collection unit is configured to verify the movement direction of the elevator car based on the elevator ride acceleration data.

The execution of the movement state verification action may comprise that the data collection unit is configured to verify that the elevator ride acceleration data comprises movements state transitions required for an elevator ride in question.

The execution of the disconnected ride verification action may comprise that the data collection unit is configured to verify that the elevator ride acceleration data comprises a complete elevator ride.

The execution of the connected ride verification action may comprise that the data collection unit is configured to verify that the elevator ride acceleration data comprises only one elevator ride.

According to a second aspect, a method for monitoring elevator car movement is provided, wherein the method comprises: obtaining, by a data collection unit, acceleration data from an accelerometer attached to an elevator car, wherein the acceleration data is produced by the accelerometer representing acceleration of the elevator car and a pre-movement period of the elevator car; detecting, by the data collection unit, an elevator car start event and an elevator car stop event from the acceleration data, wherein the acceleration data between the detected elevator car start event and the detected elevator car stop event represents elevator ride acceleration data; and executing, by the data collection unit, at least one verification action to verify a correct detection the elevator car start event and/or the elevator car stop event.

The at least one verification action may comprise at least one of the following: a duration verification action, a movement direction verification action, a movement state verification action, a disconnected ride verification action, a connected ride verification action.

The execution of the duration verification action may comprise verifying that the detected elevator car stop event is actually the end of an elevator ride.

The execution of the movement direction verification action may comprise verifying the movement direction of the elevator car based on the elevator ride acceleration data.

The execution of the movement state verification action may comprise verifying that the elevator ride acceleration data comprises movements state transitions required for an elevator ride in question.

The execution of the disconnected ride verification action may comprise verifying that the elevator ride acceleration data comprises a complete elevator ride.

The execution of the connected ride verification action may comprise verifying that the elevator ride acceleration data comprises only one elevator ride.

According to a third aspect, an elevator system is provided, wherein the elevator system comprises: an elevator car configured to travel along an elevator shaft between a plurality of floors; and an elevator car movement monitoring system described above.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an elevator system.

FIG. 2 illustrates schematically an example of an elevator car movement monitoring system.

FIG. 3 illustrates schematically an example of a method for monitoring elevator car movement.

FIG. 4 illustrates schematically an example of components of a data collection unit. 25

### DESCRIPTION OF THE EXEMPLIFYING EMBODIMENTS

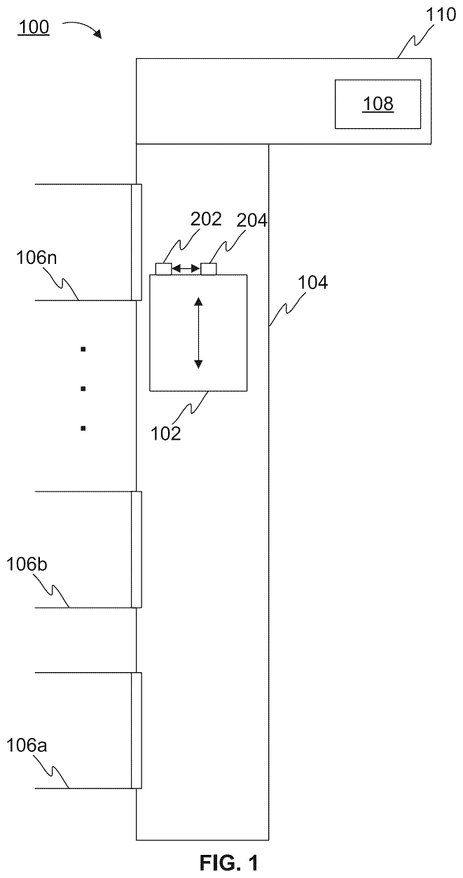

FIG. 1 illustrates schematically an example of an elevator system 100. The elevator system 100 comprises an elevator car 102 configured to travel along an elevator shaft 104 between a plurality of floors (i.e. landings) 106a-106nand an elevator control system 108. The elevator system 100 may also form an elevator group, i.e. group of two or more elevator cars 102 each travelling along a separate elevator shaft 104, configured to operate as a unit serving the same floors 106a-106n. The elevator control system 108 is configured to at least control the operations of the elevator system 100. The elevator control system 110 may locate inside a machine room 110 (as illustrated in the example of FIG. 1) or at one of the floors 106a-106n, e.g. in a machine roomless elevator system. The elevator control system 108 is communicatively coupled to the other entities of the elevator system 100. The communication between the elevator control system 108 and the other entities of the elevator system 100 may be based on one or more known communication technologies, either wired or wireless. The implementation of the elevator control system 108 may be done as a stand-alone control entity or as a distributed control environment between a plurality of stand-alone control entities, such as a plurality of servers, providing distributed control resource.

The elevator car 102 may be a one-speed elevator car or a two-speed elevator car. The elevator system 100 may further comprise one or more known elevator related entities, e.g. a counterweight, an elevator hoisting machinery, user interface devices, elevator doors, and/or safety circuit and devices, etc., which are not shown in FIG. 1 for sake of clarity.

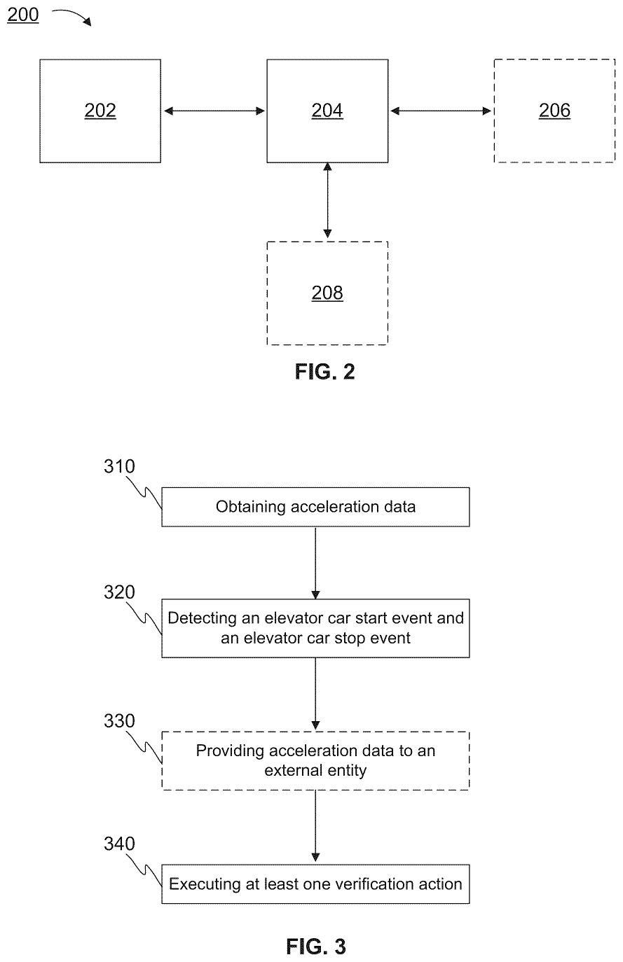

The elevator system 100 may further comprise an elevator car movement monitoring system 200 or the elevator system 100 may be associated with the elevator car movement monitoring system 200. FIG. 2 illustrates schematically an example of the elevator car movement monitoring system 200. The elevator car movement monitoring system 200 comprises an accelerometer 202 and a data collection unit 204. The elevator car movement monitoring system 200 may further comprise an external entity 206 and/or at least one additional sensor device 208. The accelerometer 202 is attached to the elevator car 102. According to a non-limiting example the accelerometer 202 may be attached on the rooftop of the elevator car 102 as illustrated in the example of FIG. 1. The attachment of the accelerometer 202 is not limited to the rooftop of the elevator car 102, but the accelerometer 202 may also be attached to any other location or part in the elevator car 102. The accelerometer 202 is configured to produce acceleration data. The accelerometer 202 may be configured to produce the acceleration data during a movement period of the elevator car 102. The movement period of the elevator car 102 comprises a period during which the elevator car 102 is moving. The movement period of the elevator car 102 may further comprise a pre-movement period and/or a post-movement period. The pre-movement period represents a predefined period preceding the movement of the elevator car 102, during which the elevator car 102 is stationary. The post-movement period of the elevator car 102 represents a predefined period following the movement of the elevator car 102, during which the elevator car 102 is stationary. The pre-movement period and/or the post-movement period enables that the acceleration data may be produced also before the movement of the elevator car 102 starts and/or after the movement of the elevator car 102 stops, respectively. The acceleration data and the producing of the acceleration data by the accelerometer 202 will be discussed more in detail later in this application. The data collection unit 204 may also be attached to the elevator car 102. According to a non-limiting example the data collection unit 204 may be attached on the rooftop of the elevator car 102 as illustrated in the example of FIG. 1. The attachment of the data collection unit 204 is not limited to the rooftop of the elevator car 102, but the data collection unit 204 may also be attached to any other location or part in the elevator car 102. The data collection unit 204 and the accelerometer 202 may be implemented as physically separate entities as illustrated in the example of FIG. 1. Alternatively, the data collection unit 204 and the accelerometer 202 may be implemented as one physical entity, i.e. the data collection unit 204 and the accelerometer 202 may be integrated into a single physical entity. The accelerometer 202 may be communicatively coupled to the data collection unit 204. The communication between the accelerometer 202 and the data collection unit 204 may be based on one or more known communication technologies, either wired or wireless. The external entity 206 is an entity being external to the elevator system 100. The external entity 206 may for example be, but is not limited to, a cloud server, a server, a data center, a service center, or a maintenance center. The external entity 206 may be communicatively coupled to the data collection unit 204. The communication between the external entity and the data collection unit 204 may be based on one or more known communication technologies, either wired or wireless. The at least one additional sensor device 208 may for example comprise at least one pressure sensor device configured to produce pressure data during the movement period of the elevator car 102. Alternatively or in addition, the at least one additional sensor device 208 may for example comprise at least one magnetometer sensor device configured to produce magnetometer data during the movement period of the elevator car 102. The at least one additional sensor device 208 may be communicatively coupled to the data collection unit 204. The communication between the at least one additional sensor device 208 and the data collection unit 204 may be based on one or more known communication technologies, either wired or wireless.

Although the elevator car movement monitoring system 200 may be comprised by the elevator system 100, there is no communicative coupling between the elevator car movement monitoring system 200 and the elevator control system 108. In other words, the entities of the elevator car movement monitoring system 200 are not communicatively coupled to the elevator control system 108. The elevator car movement monitoring system 200 is able to monitor elevator related data, e.g. the acceleration data, without the communicative coupling to the elevator control system 108.

Next an example of a method for monitoring elevator car movement is described by referring to FIG. 3. FIG. 3 schematically illustrates the method as a flow chart. The method is performed by the elevator car movement monitoring system 200 described above. As discussed in the background section, there exists challenges in the monitoring of the elevator car movement specific to two-speed elevator cars. Therefore, the elevator car monitoring system 200 and the monitoring method for monitoring the elevator car movement may preferably be used for monitoring the movement of two-speed elevator cars 102. However, the elevator car monitoring system 200 and the monitoring method for monitoring the elevator car movement may also be used for monitoring the movement of one-speed elevator cars 102.

At a step 310, the data collection unit 204 obtains from the accelerometer 202 acceleration data produced by the accelerometer 202. The data collection unit 204 may store the obtained acceleration data into a memory unit 420. As discussed above, the accelerometer 202 produces, i.e. measures, the acceleration data. The acceleration data comprises data representing acceleration of the elevator car 102. The acceleration data may further comprise other data. The other data may for example be used for deriving data from the produced acceleration data, e.g. a speed curve of the elevator car 102. The speed curve represents the speed of the elevator car 102 during the movement period of the elevator car 102. According to an example, the data collection unit 204 may further obtain from the at least one pressure sensor device the pressure data produced by the at least one pressure sensor device during period the movement of the elevator car 102 and/or from the at least one magnetometer sensor device the magnetometer data produced by the at least one magnetometer sensor device during period the movement of the elevator car 102.

Because the elevator car 102 may typically be stationary most of the time, continuous producing of the acceleration data by the accelerometer 202 is not preferred. Therefore, the acceleration data may be produced only during the movement period of the elevator car 102. This enables reducing power consumption of the accelerometer 202, especially, when the accelerometer 202 is battery operated. The accelerometer 202 may for example comprise an internal wake-up functionality, e.g. a wake-up circuitry, configured to wake up the accelerometer 202, when the movement of the elevator car 102 begins, i.e. an elevator ride is assumed to begin. For example, an acceleration threshold may be set for the internal wake up functionality. The acceleration threshold may be adjustable. When an acceleration that meets (i.e. reaches or exceeds) the acceleration threshold is detected, the internal wake-up functionality wakes up the accelerometer 202. According to an example, the accelerometer 202 may comprise a buffer with a buffering time for storing acceleration data the buffering time before the acceleration threshold is met. According to a non-limiting example, the buffering time may for example be two seconds. The buffering time may be adjustable. The acceleration data provided by the accelerometer 202 to the data collection unit 204 at the step 310 may thus also comprise the buffered acceleration data, i.e. the acceleration data stored to the buffer. This enables producing the acceleration data also at the very beginning of the elevator ride and even before the elevator car 102 is stared to move. The movement period of the elevator car 102 may comprise the buffering time. The pre-movement period of the elevator car 102 may comprise the part of the buffering time, during which the elevator car 102 is stationary. The producing of the acceleration data by the accelerometer 202 may be ended, when the movement of the elevator car 102 stops, i.e. the elevator ride is assumed to end. A delay may be added (e.g. by applying a stop delay time) after the assumed end of the elevator ride in order to ensure that the acceleration data during the elevator ride is produced. The stop delay time defines the delay between the assumed end of the elevator ride and the end of the producing of the acceleration data by the accelerometer 202. According to an example, the producing of the acceleration data by the accelerometer 202 may be forced to end by using a timeout, if no acceleration of the elevator car 102 is detected during a predefined timeout period. The acceleration data provided by the accelerometer 202 to the data collection unit 204 at the step 310 may thus also comprise the acceleration data produced during the stop delay time and/or the predefined timeout period. This enables producing the acceleration data also at the very end of the elevator ride and even after the movement of the elevator car 102 is stopped. The movement period of the elevator car 102 may comprise the stop delay time and/or the predefined timeout period. The post-movement period of the elevator car 102 may comprise the part of the stop delay time and/or the predefined timeout period, during which the elevator car 102 is stationary. After the producing of the acceleration data is ended, the accelerometer 202 may be set into a sleep state or an idle state to wait for the next movement of the elevator car 102. An elevator ride represents the movement of the elevator car 102 from one floor (i.e. a departure floor) 106a-106n to another floor (i.e. a destination floor) 106a-106n.

The elevator ride may comprise different movement states of the elevator car 102. The movement states may comprise a stationary state, at least two acceleration states, and at least one constant speed state. The at least two acceleration states comprise at least one positive acceleration state and at least one negative acceleration state. In case of the one-speed elevator car, the elevator ride comprises one constant speed state. In case of the two-speed elevator car, the elevator ride comprises two constant speed states. According to an example, the elevator ride of a one-speed elevator car may be formed by a stationary state, a first acceleration state, a constant speed state, and a second acceleration state (i.e. a deceleration state), and the stationary state. According to another example, the elevator ride of a two-speed elevator car may be formed by a stationary state, a first acceleration state, a first constant speed state, a second acceleration state (i.e. a first deceleration state), a second constant speed state, a third acceleration state (i.e. a second deceleration state), and the stationary state. The movement of the elevator car 102 may be an upward movement or a downward movement from the departure floor 106a-106n to the destination floor 106a-106n. An elevator ride upwards from the departure floor 106a-106n comprises two or more acceleration states: at least one positive acceleration state upwards and at least one negative acceleration state, i.e. a deceleration peak, upwards as the elevator car 102 reaches the destination floor 106a-106n. An elevator ride downwards from the departure floor 106a-106n, on the other hand, comprises two or more acceleration states: at least one negative acceleration state downwards and at least one positive acceleration state, i.e. a deceleration peak, downwards as the elevator car 102 reaches the destination floor 106a-106n. The data collection unit 204 may determine the movement state of the elevator car 102 based on the acceleration data. For example, the data collection unit 204 may comprise a state machine for determining the movement state of the elevator car 102. According to an example, the data collection unit 204, e.g. the state machine of the data collection unit 204, may further use the pressure data obtained from the at least one pressure sensor device and/or the magnetometer data obtained from the at least one magnetometer sensor device in the determination of the movement state of the elevator car 102.

At a step 320, the data collection unit 204 detects from the acceleration data an elevator car start event and an elevator car stop event. For example, the state machine of the data collection unit 204 may be used to detect the elevator car start event and the elevator car stop event. The elevator car start event represents the start of the elevator ride, i.e. the start of the movement of the elevator car 102 from the departure floor 106a-106n. The elevator car stop event represents the end of the elevator ride, i.e. the stopping of the movement of the elevator car 102 to the destination floor 106a-106n. The acceleration data between the detected elevator car start event and the detected elevator car stop event represents elevator ride acceleration data. The data collection unit 204 may form the elevator ride acceleration data after detecting the elevator car start event and the elevator car stop event. The data collection unit 204 may further store the elevator ride acceleration data into the memory unit 420.

At an optional step 330, the data collection unit 204 may provide, i.e. send, acceleration data to the external entity 206. The data collection unit 204 may for example provide the elevator ride acceleration data, i.e. the acceleration data between the detected elevator car start event and the detected elevator car stop event, to the external entity 206. Alternatively or in addition, the data collection unit 204 may provide the obtained acceleration data to the external entity 206. The data collection unit 204 may also provide, i.e. send, the pressure data obtained from the at least one pressure sensor device and/or the magnetometer data obtained from the at least one magnetometer sensor device to the external entity 206.

At a step 340, the data collection unit 204 executes at least one verification action to verify a correct detection of the elevator car start event and/or the elevator car stop event. The at least one verification action may be executed for the elevator ride acceleration data and/or for the obtained acceleration data, from which said elevator ride acceleration data is formed. The execution of the at least one verification action improves the reliability of the monitoring of the elevator car movement. The execution of the at least one verification action also enables detecting and marking incorrect elevator ride acceleration data. The at least one verification action may comprise at least one of the following: a duration verification action, a movement direction verification action, a movement state verification action, a disconnected ride verification action, a connected ride verification action. In the example of FIG. 3, the step 330 is performed before the step 340, but the steps 330 and 340 may also be performed in reverse order, i.e. first the step 340 and the step 330.

The execution of the duration verification action comprises that the data collection unit 204 verifies that the detected elevator car stop event is actually the end of the elevator ride. There may exist cases where the accelerometer 202 has stopped producing the acceleration data already before the end of the elevator ride causing that the end of the elevator ride is missing from the acceleration data obtained by the data collection unit 204 from the accelerometer 202, which in turn causes that the detected elevator car stop event is not the end of the elevator ride, but instead it is the end of the producing of the acceleration data. For example, the producing of the acceleration data by the accelerometer 202 may have been forced to end by the timeout, if acceleration of the elevator car 102 was not detected during the predefined timeout period, even if the elevator ride is still incomplete, e.g. during the constant speed state of the elevator ride. In response to detecting that the detected elevator car stop event is not actually the end of the elevator ride, the data collection unit 204 may mark the elevator ride acceleration data incorrect. The data collection unit 204 may further inform the external entity 206 that said elevator ride acceleration data is incorrect and/or the acceleration data, from which said elevator ride acceleration data is formed, is incorrect.

The execution of the movement direction verification action comprises that the data collection unit 204 verifies the movement direction of the elevator car based on the elevator ride acceleration data. The verification of the movement direction may for example comprise that the data collection unit 204 determines the movement direction of the elevator car 102 by using two different movement direction determination methods. If the determined movement directions differ from each other, it may be an indication that the elevator ride acceleration data is incorrect. Thus, in response to detecting that the determined movement directions differ from each other, the data collection unit 204 may mark the elevator ride acceleration data incorrect. The data collection unit 204 may further inform the external entity 206 that said elevator ride acceleration data is incorrect and/or the acceleration data, from which said elevator ride acceleration data is formed, is incorrect. The two movement direction determination methods may be used for determining the movement direction as long as they are different from each other. Non-limiting examples of the two different movement direction determination methods may comprise, but are not limited to, a cumulative sum calculation from the acceleration data and an iteration of the movement states of the elevator car 102.

The execution of the movement state verification action comprises that the data collection unit 204 verifies that the elevator ride acceleration data comprises movements state transitions required for the elevator ride in question. The movement state action may for example be performed by using the speed curve defined based on the elevator ride acceleration data. For example, the data collection unit 204 may detect movement state transitions detected from the speed curve and compare the detected movement state transitions to the movements state transitions required for the elevator ride in question. According to a non-limiting example the data collection unit 204 may detect the following movement state transitions from an example speed curve: one movement state transition from a stationary state to a first acceleration state, one movement state transition from the first acceleration state to a constant speed state, one movement state transition from the constant speed state to a second acceleration state (i.e. a deceleration state), and one movement state transition from the second acceleration state back to the stationary state. In response to detecting that the detected movement state transitions do not correspond to the movements state transitions required for the elevator ride in question, the data collection unit 204 may mark the elevator ride acceleration data incorrect. The data collection unit 204 may further inform the external entity 206 that said elevator ride acceleration data is incorrect and/or the acceleration data, from which said elevator ride acceleration data is formed, is incorrect.

The execution of the disconnected ride verification action comprises that the data collection unit 204 verifies that the elevator ride acceleration data comprises a complete elevator ride. In other words, in the disconnected ride verification action, the data collection unit 204 verifies that the elevator ride acceleration data does not comprise only a part of the elevator ride or parts of two consecutive elevator rides. For example, there may exists cases where the end of the elevator ride may be missing from the elevator ride acceleration data. Alternatively or in addition, there may exist cases where the one elevator ride may for example be divided into two consecutive elevator ride acceleration data, e.g. into first elevator ride acceleration data and second elevator ride acceleration data, wherein the first elevator ride acceleration data comprises the beginning of the elevator ride and the second elevator ride acceleration data comprises the end of the same elevator ride. According to yet another example, there may exists cases where one elevator ride acceleration data may for example comprise parts of two consecutive elevator rides, e.g. the end of the first elevator ride and the beginning of the second elevator ride, wherein the first and the second elevator rides are consecutive elevator rides. The disconnected ride verification action may for example be performed by using the speed curve defined based on the elevator ride acceleration data. In response to detecting that the elevator ride acceleration data does not comprise a complete elevator ride, the data collection unit 204 may mark the elevator ride acceleration data incorrect. The data collection unit 204 may further inform the external entity 206 that said elevator ride acceleration data is incorrect and/or the acceleration data, from which said elevator ride acceleration data is formed, is incorrect. Alternatively or in addition, in response to detecting that the elevator ride acceleration data does not comprise a complete elevator ride, the data collection unit 204 may dynamically adjust the stop delay parameter by increasing the stop delay parameter. This improves the correct detection of the elevator car start event and/or the elevator car stop event from the obtained acceleration data of the forthcoming elevator rides, which also improves the correctness of the elevator ride acceleration data of the forthcoming elevator rides.

The execution of the connected ride verification action comprises that the data collection unit 204 verifies that the elevator ride acceleration data comprises only one elevator ride. In other words, in the connected ride verification action the data collection unit 204 verifies that the elevator ride acceleration data does not comprise multiple, i.e. two or more, elevator rides. The connected ride verification action may for example be performed by using the speed curve defined based on the elevator ride acceleration data. In response to detecting that the elevator ride acceleration data comprises multiple elevator rides, the data collection unit 204 may mark the elevator ride acceleration data incorrect. The data collection unit 204 may further inform the external entity 206 that said elevator ride acceleration data is incorrect and/or the acceleration data, from which said elevator ride acceleration data is formed, is incorrect. Alternatively or in addition, in response to detecting that the elevator ride acceleration data comprises multiple elevator rides, the data collection unit 204 may dynamically adjust the stop delay parameter by decreasing the stop delay parameter. This improves the correct detection of the elevator car start event and/or the elevator car stop event from the obtained acceleration data of the forthcoming elevator rides, which also improves the correctness of the elevator ride acceleration data of the forthcoming elevator rides.

According to an example, the data collection unit 204 may further use the pressure data obtained from the at least one pressure sensor device and/or the magnetometer data obtained from the at least one magnetometer sensor device in at least one verification action of the executed at least one verification actions discussed above, i.e. in at least one of the following: the duration verification action, the movement direction verification action, the movement state verification action, the disconnected ride verification action, the connected ride verification action.

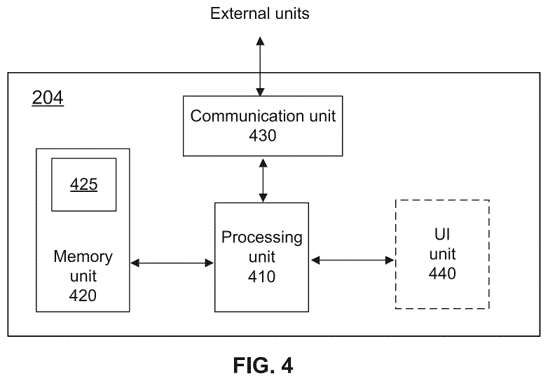

FIG. 4 illustrates schematically an example of components of the data collection unit 204. The data collection unit 204 may comprise a processing unit 410 comprising one or more processors, the memory unit 420 comprising one or more memories, a communication unit 430 comprising one or more communication devices, and possibly a user interface (UI) unit 440. The mentioned elements may be communicatively coupled to each other with e.g. a communication bus. The memory unit 420 may store and maintain portions of a computer program (code) 425, the acceleration data, the elevator ride acceleration data, and any other data. The computer program 425 may comprise instructions which, when the computer program 425 is executed by the processing unit 410 of the data collection unit 204 may cause the processing unit 410, and thus the data collection unit 204 to carry out desired tasks, e.g. one or more of the method steps described above. The processing unit 410 may thus be arranged to access the memory unit 420 and retrieve and store any information therefrom and thereto. For sake of clarity, the processor herein refers to any unit suitable for processing information and control the operation of the data collection unit 204, among other tasks. The operations may also be implemented with a microcontroller solution with embedded software. Similarly, the memory unit 420 is not limited to a certain type of memory only, but any memory type suitable for storing the described pieces of information may be applied in the context of the present invention. The communication unit 430 provides one or more communication interfaces for communication with any other unit, e.g. the accelerometer 202, the external unit 206, one or more databases, and/or with any other unit. The user interface unit 440 may comprise one or more input/output (I/O) devices, such as buttons, keyboard, touch screen, microphone, loudspeaker, display and so on, for receiving user input and outputting information. The computer program 425 may be a computer program product that may be comprised in a tangible nonvolatile (non-transitory) computer-readable medium bearing the computer program code 425 embodied therein for use with a computer, i.e. the data collection unit 204.

The specific examples provided in the description given above should not be construed as limiting the applicability and/or the interpretation of the appended claims. Lists and groups of examples provided in the description given above are not exhaustive unless otherwise explicitly stated.

1. An elevator car movement monitoring system for monitoring movement of an elevator car, wherein the elevator car movement monitoring system comprises :
an accelerometer attached to an elevator car and configured to produce acceleration data representing acceleration of the elevator car, and
a data collection unit configured to:
obtain the acceleration data from the accelerometer;
detect an elevator car start event and an elevator car stop event from the acceleration data, wherein the acceleration data between the detected elevator car start event and the detected elevator car stop event represents elevator ride acceleration data; and
execute at least one verification action to verify a correct detection the elevator car start event and/or the elevator car stop event.

2. The elevator car movement monitoring system according to claim 1, wherein the at least one verification action comprises at least one of the following: a duration verification action, a movement direction verification action, a movement state verification action, a disconnected ride verification action, a connected ride verification action.

3. The elevator car movement monitoring system according to claim 2, wherein the execution of the duration verification action comprises that the data collection unit is configured to verify that the detected elevator car stop event is actually the end of an elevator ride.

4. The elevator car movement monitoring system according to claim 2, wherein the execution of the movement direction verification action comprises that the data collection unit is configured to verify the movement direction of the elevator car based on the elevator ride acceleration data.

5. The elevator car movement monitoring system according to claim 2, wherein the execution of the movement state verification action comprises that the data collection unit is configured to verify that the elevator ride acceleration data comprises movements state transitions required for an elevator ride in question.

6. The elevator car movement monitoring system according to claim 2, wherein the execution of the disconnected ride verification action comprises that the data collection unit is configured to verify that the elevator ride acceleration data comprises a complete elevator ride.

7. The elevator car movement monitoring system according to claim 2, wherein the execution of the connected ride verification action comprises that the data collection unit is configured to verify that the elevator ride acceleration data comprises only one elevator ride.

8. A method for monitoring elevator car movement comprising:
obtaining, by a data collection unit, acceleration data from an accelerometer attached to an elevator car, wherein the acceleration data is produced by the accelerometer representing acceleration of the elevator car;
detecting, by the data collection unit, an elevator car start event and an elevator car stop event from the acceleration data, wherein the acceleration data between the detected elevator car start event and the detected elevator car stop event represents elevator ride acceleration data; and
executing, by the data collection unit, at least one verification action to verify a correct detection the elevator car start event and/or the elevator car stop event.

9. The method according to claim 8, wherein the at least one verification action comprises at least one of the following: a duration verification action, a movement direction verification action, a movement state verification action, a disconnected ride verification action, a connected ride verification action.

10. The method according to claim 9, wherein the execution of the duration verification action comprises verifying that the detected elevator car stop event is actually the end of an elevator ride.

11. The method according to claim 9, wherein the execution of the movement direction verification action comprises verifying the movement direction of the elevator car based on the elevator ride acceleration data.

12. The method according to claim 9, wherein the execution of the movement state verification action comprises verifying that the elevator ride acceleration data comprises movements state transitions required for an elevator ride in question.

13. The method according to claim 9, wherein the execution of the disconnected ride verification action comprises verifying that the elevator ride acceleration data comprises a complete elevator ride.

14. The method according to claim 9, wherein the execution of the connected ride verification action comprises verifying that the elevator ride acceleration data comprises only one elevator ride.

15. An elevator system comprising
an elevator car configured to travel along an elevator shaft between a plurality of floors; and
an elevator car movement monitoring system according to claim 1.

16. The elevator car movement monitoring system according to claim 3, wherein the execution of the movement direction verification action comprises that the data collection unit is configured to verify the movement direction of the elevator car based on the elevator ride acceleration data.

17. The elevator car movement monitoring system according to claim 3, wherein the execution of the movement state verification action comprises that the data collection unit is configured to verify that the elevator ride acceleration data comprises movements state transitions required for an elevator ride in question.

18. The elevator car movement monitoring system according to claim 4, wherein the execution of the movement state verification action comprises that the data collection unit is configured to verify that the elevator ride acceleration data comprises movements state transitions required for an elevator ride in question.

19. The elevator car movement monitoring system according to claim 3, wherein the execution of the disconnected ride verification action comprises that the data collection unit is configured to verify that the elevator ride acceleration data comprises a complete elevator ride.

20. The elevator car movement monitoring system according to claim 4, wherein the execution of the disconnected ride verification action comprises that the data collection unit is configured to verify that the elevator ride acceleration data comprises a complete elevator ride.
